(19) United States
(12) Patent Application Publication
(10) Pub. No.: US 2015/0012174 A1
(43) Pub. Date: Jan. 8, 2015

(54) SYSTEM AND METHOD OF CONTROLLING STATE OF CHARGE OF BATTERY IN VEHICLE

(71) Applicant: HYUNDAI MOTOR COMPANY, Seoul (KR)

(72) Inventors: Hyoungsik Kim, Hwaseong (KR); Jieun Lee, Seoul (KR)

(73) Assignee: HYUNDAI MOTOR COMPANY, Seoul (KR)

(21) Appl. No.: 14/143,859

(22) Filed: Dec. 30, 2013

(30) Foreign Application Priority Data
Jul. 8, 2013 (KR) 10-2013-0079739

(51) Int. Cl. B60R 16/03

(52) U.S. Cl. CPC B60R 16/03
USPC 701/36

(57) ABSTRACT

Provided is a system and method for controlling a state of charge of a battery including: an electrical load detector configured to detect information about voltages demanded by a plurality of electrical loads mounted in a vehicle; an alternator configured to generate a voltage with power of an engine, and supply the generated voltage to the plurality of electrical loads; a battery configured to supply a voltage during starting the engine, and supply a voltage to the plurality of electrical loads; a battery detector configured to detect information about a state of charge (SOC) of the battery; and an electronic control unit (ECU) configured to determine a control mode based on a driving pattern of a driver, and control power generation of the alternator based on the determined control mode and the SOC of the battery.

### CROSS-REFERENCE TO RELATED APPLICATION

This application claims priority to and the benefit of Korean Patent Application No. 10-2013-0079739 filed in the Korean Intellectual Property Office on Jul. 8, 2013, the entire contents of which are incorporated herein by reference.

### BACKGROUND

(a) Technical Field

The present disclosure relates to a system and a method of controlling a state of charge of a battery in a vehicle, and more particularly, to a system and a method of controlling a state of charge of a battery, which optimizes a state of charge (SOC) of a battery by calculating a driving pattern based on vehicle information and controlling the amount of power generated by an alternator according to the calculated driving pattern.

(b) Description of the Related Art

Telematics is a term in which telecommunication is combined with informatics, and is defined as next generation information providing services for a vehicle through a combination of the automotive industry and IT techniques, in which wireless communication, a vehicle terminal, contents, and the like are organically related with each other.

The telematics technology may collect vehicle information, provide various multimedia services, such as traffic and driving information, emergency situation response information, remote vehicle diagnosis services, and connect to the Internet by using wireless communication technology and global positioning system (GPS) technology.

Further, systems for improving fuel efficiency have been applied to vehicles. In an idle stop and go (ISG) system, when a vehicle is stopped so that idling is maintained for a predetermined time, and a predetermined condition is satisfied, an engine is idle stopped. Also, when a starting intention according to a release of a brake pedal or a tip-in of an accelerator pedal is detected in a state where the engine is stopped, the ISG system restarts the engine.

A power generation control system is a system for controlling the amount of power generated by determining a target generation voltage according to a driving condition of a vehicle, such as acceleration, deceleration, cruise, and an idle condition, based on current and voltage information about a battery from various sensors mounted in a battery electrode, and for controlling driving of an alternator by an engine control unit (ECU).

For example, the ECU generates a large amount of electrical energy by increasing the amount of power generated by the alternator during the deceleration, and charges a battery with electrical energy left after an electrical load uses the electrical energy. The ECU also decreases the amount of power generated by the alternator during acceleration, cruise, and idling, and operates an electrical load by using energy stored in the battery, thereby minimizing fuel consumption.

The aforementioned power generation control system in the related art has a problem in that a lifespan of a battery is shortened by simply controlling a target generation voltage according to a driving condition. For example, in a case where a driving pattern of a driver is disadvantageous to the charge of a battery, such as where the number of times starting is large, while the driving time is short, a state of charge (SOC) of a battery is decreased to a predetermined amount (e.g., 70%) or lower due to discharge of the battery. When a relatively long time is passed in which the state of charge of the battery is the predetermined amount or lower, durability of the battery is decreased.

Accordingly, a method of controlling a state of charge of a battery which considers a driving pattern of a driver by using a telematics technology has been demanded.

The above information disclosed in this Background section is only for enhancement of understanding of the background of the disclosure, and therefore it may contain information that does not form the related art that is already known in this country to a person of ordinary skill in the art.

### SUMMARY

The disclosed embodiments have been made in an effort to provide a system and a method of controlling a state of charge of a battery of a vehicle, which optimizes a state of charge of a battery by receiving a driving pattern calculated from a telematics server, and controls charge or discharge of the battery according to the driving pattern.

An exemplary embodiment of the present disclosure provides a system for controlling a state of charge of a battery, including: an electrical load detector configured to detect information about voltages demanded by a plurality of electrical loads mounted in a vehicle; an alternator configured to generate a voltage with power of an engine, and supply the generated voltage to the plurality of electrical loads; a battery configured to supply a voltage during starting the engine, and supply a voltage to the plurality of electrical loads; a battery detector configured to detect information about a state of charge (SOC) of the battery; and an electronic control unit (ECU) configured to determine a control mode based on the determined control mode and a driving pattern of a driver, and control a power generation of the alternator based on the SOC of the battery.

The system may further include: an ignition detector configured to detect information about turning the engine on or off; an engine speed detector configured to detect information about a number of revolutions of the engine; a vehicle speed detector configured to detect vehicle speed information; and a telematics terminal configured to collect vehicle information according to a driving condition of the driver from the ECU, transmit the collected vehicle information to a remote location, receive a driving pattern of the driver calculated from the telematics server, and provide the driving pattern to the ECU.

The driving pattern may include at least one of an average number of times of starting the engine, a deceleration driving ratio, and an average hour of use of the plurality of electrical loads.

The control mode may include a first control mode, which may be set in a case where the average driving time is shorter than a first predetermined time, the average number of times of starting the engine is greater than a predetermined number of times, the deceleration driving ratio is less than a predetermined ratio, or the average duration (e.g., hours) of use of the plurality of electrical loads is greater than a second predetermined time. In a case where the control mode is the first control mode, when the SOC of the battery is less than a first reference state, the ECU may convert a power generation control to a deactivation state, and activate a battery charge control to charge the battery.

The control mode may further include a second control mode, which may be set in a case where the average driving time is equal to or greater than the first predetermined time, the average number of times of starting the engine is equal to or less than the predetermined number of times, the deceleration driving ratio is equal to or greater than the predetermined ratio, and the average duration (e.g., hours) of use of the plurality of electrical loads is equal to or less than the second predetermined time. In a case where the control mode is the second control mode, when the SOC of the battery exceeds a second reference state, the ECU may activate a battery discharge control to supply a voltage to the plurality of electrical loads for each third predetermined time.

Another exemplary embodiment of the present disclosure provides a method of controlling a state of charge of a battery, including: setting a control mode based on a driving pattern including an average driving time; detecting a state of charge (SOC) of a battery; and controlling a power generation of an alternator according to the detected state of charge (SOC) of a battery based on the set control mode.

The driving pattern may include at least one of an average number of times of starting the engine, a deceleration driving ratio, and an average duration (e.g., hours) of use of the plurality of electrical loads.

In the setting of the control mode, a first control mode may be set in a case where the average driving time is less than a first predetermined time, the average number of times of starting the engine is greater than a predetermined number of times, the deceleration driving ratio is less than a predetermined ratio, and the average duration (e.g., hours) of use of the plurality of electrical loads is greater than a second predetermined time. When the first control mode is set, the controlling of the power generation of the alternator may include: comparing the SOC of the battery with a first reference state; and when the SOC of the battery is less than the first reference state, converting a power generation control to a deactivation state, and activating a battery charge control to charge the battery.

In the setting of the control mode, a second control mode may be set in a case where the average driving time is equal to or greater than the first predetermined time, the average number of times of starting the engine is equal to or less than the predetermined number of times, the deceleration driving ratio is equal to or greater than the predetermined ratio, and the average duration (e.g., hours) of use of the plurality of electrical loads is equal to or less than the second predetermined time. When the second control mode is set, the controlling of the power generation of the alternator may include: comparing the SOC of the battery with a second reference state for each third predetermined time; and when the SOC of the battery exceeds the second reference state, activating a battery discharge control to supply a voltage to the plurality of electrical loads.

The method according to another exemplary embodiment of the present disclosure may further include: collecting vehicle information and transmitting the collected vehicle information to a telematics server; and receiving the driving pattern calculated based on the vehicle information from the telematics server.

### BRIEF DESCRIPTION OF THE DRAWINGS

FIG. 1 is an exemplary block diagram schematically illustrating a configuration of a system for controlling a state of charge of a battery according to an exemplary embodiment of the present disclosure.

FIG. 2 is an exemplary flowchart illustrating a simplified method of determining a control mode by calculating a driving pattern of a driver according to the exemplary embodiment of the present disclosure.

FIG. 3 is an exemplary flowchart illustrating a simplified method of controlling a state of charge of a battery according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

<Description of symbols>

| | |
|---|---|
| 10: Ignition detector | 20: Engine speed detector |
| 30: Vehicle speed detector | 40: Electrical load |
| 45: Electrical load detector | 50: battery |
| 55: Battery detector | 60: Alternator |
| 70: ECU(Electronic Control Unit) | 80: Telematics terminal |
| 100: Vehicle | 200: Telematics server |

### DETAILED DESCRIPTION OF THE EMBODIMENTS

Hereinafter, the present invention will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods may be executed by at least one control unit. The term “control unit” refers to a hardware device that includes a memory and a processor. The memory is configured to store program instructions, and the processor is configured to execute the program instructions to perform one or more processes which are described further below. Moreover, it is understood that the below methods may be executed by an apparatus comprising the control unit, whereby the apparatus is known in the art to be suitable for controlling a state of charge of a battery of a vehicle.

Furthermore, the control unit of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

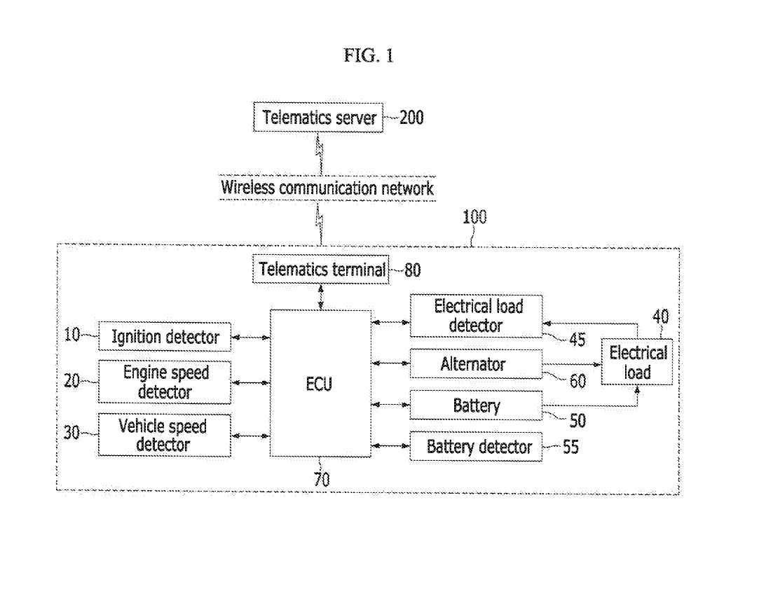

FIG. 1 is an exemplary block diagram schematically illustrating a configuration of a system for controlling a state of charge of a battery according to an exemplary embodiment of the present disclosure.

Referring to FIG. 1, a system for controlling a state of charge of a battery according to an exemplary embodiment of the present disclosure includes an ignition detector 10, a engine speed detector 20, a vehicle speed detector 30, electrical loads 40, an electrical load detector 45, a battery 50, a battery detector 55, an alternator 60, and an electronic control unit (ECU) 70. The system for controlling the state of charge of the battery according to the exemplary embodiment of the present disclosure may further include a telematics terminal 80 and a telematics server 200 for transceiving a driving pattern.

The ignition detector 10 provides information about turning an engine on or off to the ECU 70.

The engine speed detector 20 may be a crank angle sensor or a cam angle sensor. The engine speed detector 20 provides information about the number of revolutions of the engine based on a change in an angle of a crank shaft or a change in an angle of a cam shaft to the ECU 70.

The vehicle speed detector 30 detects a current speed of the vehicle and provides the detected vehicle speed to the ECU 70.

The electrical loads 40 include a plurality of components mounted in the vehicle and driven by a power source. The electrical loads may include, for example, an air conditioning apparatus, a wiper device, head lamps, a blower, heating lines, and the like.

The electrical load detector 45 detects information about voltages demanded in the plurality of electrical loads 40 and provides the detected information to the ECU 70.

The battery 50 stores electrical energy, and supplies a voltage during the starting of the engine and the re-starting of the engine. Further, the battery 50 supplies a necessary voltage to the plurality of electrical loads 40 by using stored energy during acceleration, cruise, and idling, in which the amount of power generated of the alternator 60 is low.

The battery detector 55 detects information including a voltage, a current, a temperature, and a state of charge (SOC) of the battery 50 and provides the detected information to the ECU 70.

The alternator 60 generates a voltage with power of the engine. The amount of power generated is adjusted according to a control of the ECU 70. The amount of power generated also supplies a voltage to the plurality of electrical loads 40, and supplies a residual generated voltage to the battery 50 as a charging voltage. The alternator 60 may provide information about the amount of power generated to the ECU 70, and the ECU 70 may perform a feedback control.

The ECU 70 may be implemented with one or more micro processors operated by a predetermined program, and the predetermined program may include a series of commands for performing each step included in a method of controlling a state of charge of a battery according to an exemplary embodiment of the present disclosure to be described below.

The ECU 70 controls the alternator 60 and the battery 50 based on a driving pattern of a driver and a state of charge (SOC) of the battery provided from the battery detector 55. When the driving pattern of the driver is disadvantageous to the charge of the battery (e.g., in a case where an average driving time is short, the average number of times of starting the engine is large, a deceleration driving ratio is low, and/or a frequency of use of the electrical load is high), the ECU 70 may deactivate the power generation control and activate the battery charge control, thereby improving durability of the battery.

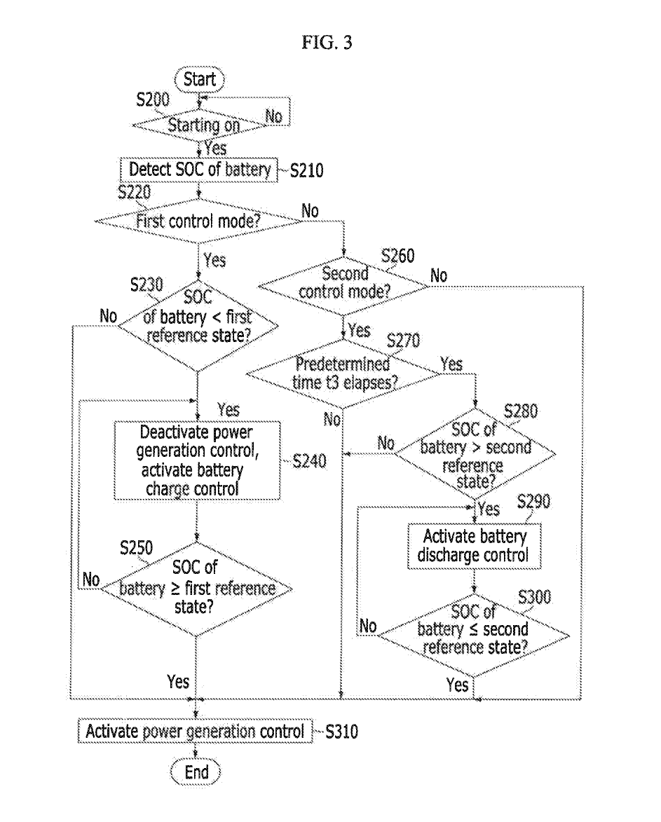

On the other hand, when the driving pattern of the driver is advantageous to the charge of the battery (e.g., in a case where an average driving time is long, the average number of times of starting the engine is small, a deceleration driving ratio is high, and/or a frequency of use of the electrical load is low), the ECU 70 expands a region in which the power generation control is available by activating the battery discharge control, thereby minimizing fuel consumption. Particular contents thereof will be described below with reference to FIG. 3.

The telematics terminal 80 collects vehicle information from the ECU 70, and transmits the collected vehicle information to the telematics server 200 through a wireless communication network. Further, the telematics terminal 80 receives the driving pattern of the driver from the telematics server 200 and provides the received driving pattern of the driver to the ECU 70.

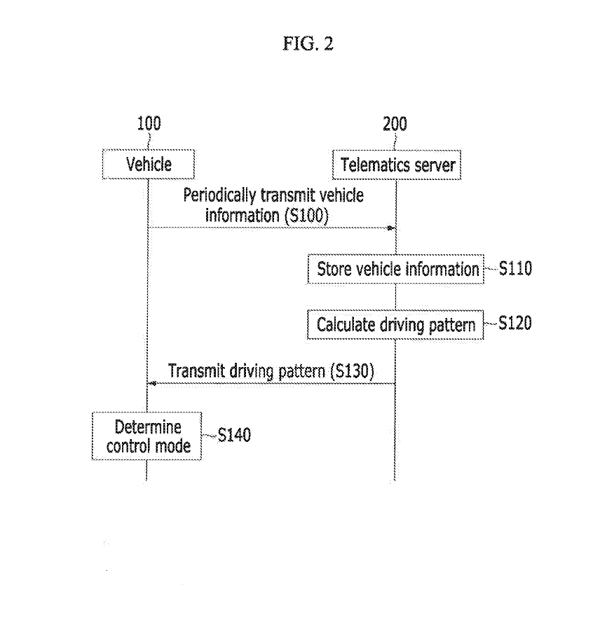

The telematics server 200 accumulates information received from the telematics terminal 80, and calculates the driving pattern of the driver based on the accumulated information. The telematics server 200 transmits the calculated driving pattern to the telematics terminal. Particular operations of the telematics terminal 80 and the telematics server 200 will be described below with reference to FIG. 2.

FIG. 2 is an exemplary flowchart illustrating a simplified method of determining a control mode by calculating a driving pattern of a driver according to the exemplary embodiment of the present disclosure.

Referring to FIG. 2, first, the telematics terminal 80 mounted in the vehicle 100 transmits vehicle information to the telematics server 200 through the wireless communication network (S100). The vehicle information may be periodically transmitted. The vehicle information is information which the telematics terminal 80 collects from the ECU 70. The vehicle information may include information about turning the engine on or off, vehicle speed information, acceleration/deceleration information, driving time information, battery information, and information about use of the plurality of electrical loads.

The telematics server 200 stores the vehicle information received from the telematics terminal 80 (S110). As the number of pieces of the information received from the telematics terminal 80 is increased, the vehicle information is accumulated.

The telematics server 200 calculates a driving pattern of a driver based on the accumulated vehicle information (S120). The telematics server 200 may store the driving pattern of the driver, and update the driving pattern of the driver based on the received vehicle information.

The driving pattern may be an average driving time, the average number of times of starting the engine, a deceleration driving ratio, or an average duration (e.g., hours) of use of the plurality of electrical loads. The average driving time may be an average value of driving hours for each term (e.g., daily, weekly, or monthly) after starting. The average number of times of starting the engine may also include the number of times of re-starting of the engine according to an ISG system. The deceleration driving ratio may be calculated based on the vehicle information (e.g., acceleration, deceleration, cruise, and idling). The average duration (e.g., hours) of use of the plurality of electrical loads may be an average value of the duration of use of the plurality of electrical loads for each term (e.g., daily, weekly, or monthly).

The telematics server 200 transmits the calculated driving pattern to the telematics terminal 80 (S130). The telematics terminal 80 provides the driving pattern to the ECU 70.

The ECU 70 determines a control mode based on the driving pattern of the driver (S140). The control mode may include a first control mode and a second control mode. In addition, the control mode may further include a third control mode.

In a case where the driving pattern of the driver is disadvantageous to the charge of the battery, the ECU 70 sets the first control mode to prevent a lifespan of the battery from being shortened. On the other hand, in a case where the driving pattern of the driver is advantageous to the charge of the battery, the ECU 70 sets the second control mode to maximize an increase in fuel efficiency.

The first control mode may be set in a case where the average driving time is less than a predetermined time t1, the average number of times of starting is greater than a predetermined number of times, the deceleration driving ratio is less than a predetermined ratio, and the average duration (e.g., hours) of use of the plurality of electrical loads is greater than a predetermined time t2. In contrast, the second control mode may be set in a case where the average driving time is equal to or greater than the predetermined time t1, the average number of times of starting is equal to or less than the predetermined number of times, the deceleration driving ratio is equal to or greater than the predetermined ratio, and the average duration (e.g., hours) of use of the plurality of electrical loads is equal to or less than the predetermined time t2. The predetermined time t1, the predetermined number of times, the predetermined ratio, and the predetermined time t2 may be values which are determined by those skilled in the art; however, the method of setting the control mode by the ECU 70 is not limited thereto.

The third control mode is set in a case where the control mode is not the first control mode and the second control mode, but instead is a mode by which the power generation control in the related art is performed.

FIG. 3 is an exemplary flowchart illustrating a simplified method of controlling a state of charge of a battery according to an exemplary embodiment of the present disclosure.

Referring to FIG. 3, the ECU 70 determines a starting-on of the engine based on information provided from the ignition detector 10 (S200).

The ECU 70 detects a current state of charge (SOC) of the battery from the battery detector 55 (S210).

The ECU 70 determines whether a set control mode is the first control mode (S220).

When the first control mode is set, the ECU 70 compares the SOC of the battery with a first reference state (S230). The first reference state may be set to a value which is determined by those skilled in the art considering improvement of durability of the battery, and may be, for example, 100%.

When the SOC of the battery is less than the first reference state, the ECU 70 converts a power generation control to a deactivation state, and activates a battery charge control to charge the battery 50 (S240). Accordingly, in a case where the driving pattern of the driver is disadvantageous to the charge of the battery 50, it is possible to prevent a lifespan of the battery from being shortened. Step S240 may be performed until the SOC of the battery is the first reference state (S250).

When the SOC of the battery is the first reference state, the ECU 70 activates the power generation control (S310). Accordingly, a generated voltage of the alternator 60 activates only the plurality of electrical loads 40, thereby decreasing fuel consumption.

When the set control mode is not the first control mode, the ECU 70 determines whether the set control mode is the second control mode (S260). When the set control mode is not the second control mode, the ECU 70 determines that the set control mode is the third control mode, and activates the power generation control (S310).

When the set control mode is set as the second control mode, the ECU 70 determines whether a predetermined time t3 elapses (S270).

When the predetermined time t3 elapses, the ECU 70 compares the SOC of the battery as a second reference state (S280). The second reference state may be set to a value which is determined by those skilled in the art considering improvement of fuel efficiency, and may be, for example 75%.

When the SOC of the battery exceeds the second reference state, the ECU 70 activates a battery discharge control (S290). Accordingly, the voltage of the battery 50 activates the plurality of electrical loads 40, so that a region, in which the power generation control is available, is expanded. Accordingly, in a case where the driving pattern of the driver is a condition advantageous to the charge of the battery 50, it is possible to maximize improvement of fuel efficiency.

Step S290 may be performed until the SOC of the battery is the second reference state (S300).

Accordingly, according to the exemplary embodiment of the present disclosure, it is possible to optimize the SOC of the battery by utilizing the driving pattern of the driver by using the telematics technology.

In a case where the driving pattern of the driver is a condition disadvantageous to the charge of the battery 50, the ECU 70 deactivates the power generation control until the SOC of the battery reaches the set state (e.g., “the first reference state”), and activates the battery charge control, thereby improving durability of the battery 50. Conversely, in a case where the driving pattern of the driver is a condition advantageous to the charge of the battery 50, the ECU 70 expands the region, in which the power generation control is available, by using energy stored in the battery 50 until the SOC of the battery reaches the set state (e.g., “the second reference state”), thereby minimizing fuel consumption.

Since the telematics technology is used, it is possible to introduce a customer's vehicle to an A/S center by recognizing a state of a battery according to data accumulated in the telematics server 200.

While this invention has been described in connection with what is presently considered to be practical exemplary embodiments, it is to be understood that the scope of the present disclosure is not limited to the disclosed embodiments, but, on the contrary, is intended to cover various modifications and equivalent arrangements included within the spirit and scope of the appended claims.

What is claimed is:

1. A system for controlling a state of charge of a battery, comprising:
an electrical load detector configured to detect information about voltages demanded by a plurality of electrical loads mounted in a vehicle;
an alternator configured to generate a voltage with power of an engine, and supply the generated voltage to the plurality of electrical loads;
a battery configured to supply a voltage during a starting of the engine, and supply a voltage to the plurality of electrical loads;
a battery detector configured to detect information about a state of charge (SOC) of the battery; and
an electronic control unit (ECU) configured to determine a control mode based on a driving pattern of a driver, and control a power generation of the alternator based on the determined control mode and the SOC of the battery.

2. The system of claim 1, further comprising:
an ignition detector configured to detect information about turning the engine on or off;
an engine speed detector configured to detect information about the number of revolutions of the engine;
a vehicle speed detector configured to detect vehicle speed information; and
a telematics terminal configured to collect vehicle information according to a driving condition of the driver from the ECU, transmit the collected vehicle information to a remote location, receive the driving pattern of the driver calculated from a telematics server, provide the driving pattern to the ECU.

3. The system of claim 1, wherein:
the driving pattern includes at least one of: an average driving time, an average number of times of starting the engine, a deceleration driving ratio, and an average duration of use of the plurality of electrical loads.

4. The system of claim 3, wherein:
the control mode includes a first control mode, and
the first control mode is set in a case where the average driving time is less than a first predetermined time, the average number of times of starting the engine is greater than a predetermined number of times, the deceleration driving ratio is less than a predetermined ratio, or the average duration of use of the plurality of electrical loads is greater than a second predetermined time.

5. The system of claim 4, wherein:
when the control mode is the first control mode, and
when the SOC of the battery is less than a first reference state, the ECU converts a power generation control to a deactivation state, and activates a battery charge control to charge the battery.

6. The system of claim 4, wherein:
the control mode further includes a second control mode, and
the second control mode is set in a case where the average driving time is equal to or greater than the first predetermined time, the average number of times of starting the engine is equal to or less than the predetermined number of times, the deceleration driving ratio is equal to or greater than the predetermined ratio, or the average duration of use of the plurality of electrical loads is equal to or less than the second predetermined time.

7. The system of claim 6, wherein:
when the control mode is the second control mode, and
when the SOC of the battery exceeds a second reference state, the ECU activates a battery discharge control to supply a voltage to the plurality of electrical loads for a third predetermined time.

8. A method of controlling a state of charge (SOC) of a battery, comprising:
setting a control mode based on a driving pattern including an average driving time;
detecting the SOC of a battery; and
controlling a power generation of an alternator according to the detected SOC of the battery based on the set control mode.

9. The method of claim 8, wherein:
the driving pattern further includes at least one of: an average number of times of starting an engine, a deceleration driving ratio, and an average duration of use of the plurality of electrical loads.

10. The method of claim 9, wherein:
in the setting of the control mode,
a first control mode is set in a case where the average driving time is less than a first predetermined time, the average number of times of starting the engine is greater than a predetermined number of times, the deceleration driving ratio is less than a predetermined ratio, or the average duration of use of the plurality of electrical loads is greater than a second predetermined time.

11. The method of claim 10, wherein:
when the first control mode is set,
the controlling of the power generation of the alternator includes:
comparing the SOC of the battery with a first reference state; and
when the SOC of the battery is less than the first reference state, converting a power generation control to a deactivation state, and activating a battery charge control to charge the battery.

12. The method of claim 10, wherein:
in the setting of the control mode,
a second control mode is set in a case where the average driving time is equal to or greater than the first predetermined time, the average number of times of starting the engine is equal to or less than the predetermined number of times, the deceleration driving ratio is equal to or greater than the predetermined ratio, or the average duration of use of the plurality of electrical loads is equal to or less than the second predetermined time.

13. The method of claim 12, wherein:
when the second control mode is set,
the controlling of the power generation of the alternator includes:
comparing the SOC of the battery with a second reference state for a third predetermined time; and
when the SOC of the battery exceeds the second reference state, activating a battery discharge control to supply a voltage to the plurality of electrical loads.

14. The method of claim 8, further comprising:
collecting vehicle information and transmitting the collected vehicle information to a telematics server; and
receiving the driving pattern calculated based on the vehicle information from the telematics server.

15. A non-transitory computer readable medium containing program instructions for controlling a state of charge (SOC) of a battery, the computer readable medium comprising:
program instructions that set a control mode based on a driving pattern including an average driving time;
program instructions that detect the SOC of a battery; and
program instructions that control a power generation of an alternator according to the detected SOC of the battery based on the set control mode.

16. The computer readable medium of claim 15, wherein:
the driving pattern further includes at least one of: an average number of times of starting an engine, a deceleration driving ratio, and an average duration of use of the plurality of electrical loads.

17. The computer readable medium of claim 16, wherein the program instructions that set the control mode further comprise:
program instructions that set a first control mode in a case where the average driving time is less than a first predetermined time, the average number of times of starting the engine is greater than a predetermined number of times, the deceleration driving ratio is less than a predetermined ratio, or the average duration of use of the plurality of electrical loads is greater than a second predetermined time.

18. The computer readable medium of claim 17, wherein:
when the first control mode is set,
the program instructions that control the power generation of the alternator further comprise:
program instructions that compare the SOC of the battery with a first reference state; and
when the SOC of the battery is less than the first reference state, program instructions that convert a power generation control to a deactivation state, and activating a battery charge control to charge the battery.

19. The computer readable medium of claim 17, wherein the program instructions that set the control mode further comprise:
program instructions that set a second control mode in a case where the average driving time is equal to or greater than the first predetermined time, the average number of times of starting the engine is equal to or less than the predetermined number of times, the deceleration driving ratio is equal to or greater than the predetermined ratio, or the average duration of use of the plurality of electrical loads is equal to or less than the second predetermined time.

20. The computer readable medium of claim 19, wherein:
when the second control mode is set,
the program instructions that control the power generation of the alternator further comprise:
program instructions that compare the SOC of the battery with a second reference state for a third predetermined time; and
when the SOC of the battery exceeds the second reference state, program instructions that activate a battery discharge control to supply a voltage to the plurality of electrical loads.
